(19) United States
(12) Patent Application Publication
(10) Pub. No.: US 2017/0313957 A1
(43) Pub. Date: Nov. 2, 2017

(54) METHOD OF MANUAL DISHWASHING

(71) Applicant: The Procter & Gamble Company, Cincinnati, OH (US)

(72) Inventors: Robby Renilde Francois KEULEERS, Lippelo (BE); Pietro LUNETTO, Brussels (BE)

(21) Appl. No.: 15/498,776

(22) Filed: Apr. 27, 2017

(30) Foreign Application Priority Data
Apr. 27, 2016 (EP) 16167235.7

(51) Int. Cl. C11D 1/75; C11D 3/37; C11D 3/20; C11D 11/00; C11D 1/29

(52) U.S. Cl. CPC C11D 1/75; C11D 11/0023; C11D 1/29; C11D 3/2068; C11D 3/3723

(57) ABSTRACT

A method of manually washing dishware in soft water including the steps of delivering a cleaning composition to a volume of soft water to form a wash liquor and immersing the dishware in the liquor wherein the cleaning composition comprises anionic surfactant, amine oxide surfactant and an amphiphilic alkoxylated polyalkyleneimine.

### FIELD OF THE INVENTION

The present invention relates to a method of manually washing dishware using a detergent composition comprising anionic surfactant, amine oxide surfactant including a low-cut amine oxide and an amphiphilic alkoxylated polyalkyleneimine The method provides very good cleaning with long lasting suds in soft water.

### BACKGROUND OF THE INVENTION

The performance of hand dishwashing cleaning compositions can be linked to the hardness of the water used for the dishwashing process. Different compositions perform different under different water hardness.

Traditionally manual dishwashing has been performed by filling a sink with water, adding a dishwashing detergent to create a soapy solution, immersing the soiled articles in the solution, scrubbing the articles and rinsing to remove the remaining soils and remove the suds generated from the soapy solution from the washed articles. Users associate the presence of suds in a washing solution with good cleaning.

There is a need to provide a method of manual dishwashing that provides good cleaning and at the same time long-lasting suds when the manual dishwashing is performed with soft water.

### SUMMARY OF THE INVENTION

According to a first aspect of the invention, there is provided a method of manually washing dishware with soft water using a specific cleaning composition.

The composition comprises anionic surfactant, amine oxide surfactant, including low and mid cut amine oxide surfactants and an amphiphilic alkoxylated polyalkyleneimine The composition used in the method of the invention provides good cleaning and long lasting suds.

The composition used in the method of the invention is sometimes herein referred to as “the composition of the invention”.

By “soft water” is herein meant water having a hardness equal or less than 10 gpg, preferably less than 5 gpg (grains per gallon, i.e. a unit of water hardness defined as 1 grain (64.8 milligrams) of calcium carbonate dissolved in 1 US gallon of water (3.785412 L)).

The composition preferably comprises from about 3 to about 15%, preferably from about 5 to about 12% by weight of the composition of amine oxide surfactant. The amine oxide surfactant is a mixture of amine oxides comprising a low-cut amine oxide and a mid-cut amine oxide.

The amine oxide of the composition of the invention comprises:
a) from about 5% to about 40%, preferably from 10% to about 30% by weight of the amine oxide of low-cut amine oxide of formula R1R2R3AO wherein R1 and R2 are independently selected selected from hydrogen, C1-C4 alkyls or mixtures thereof and wherein R3 is selected from C10 alkyls or mixtures thereof; and
b) from about 60% to about 95%, preferably from about 70% to about 90% by weight of the amine oxide of mid-cut amine oxide of formula R4R5R6AO wherein R4 and R5 are independently selected from hydrogen, C1-C4 alkyls or mixtures thereof and wherein R6 is selected from C12-C16 alkyls or mixtures thereof.

The amphiphilic alkoxylated polyalkyleneimine is an alkoxylated polyethyleneimine polymer comprising a polyethyleneimine backbone. The polyethyleneimine backbone has a molecular weight of from about 400 to about 5,000, preferably from about 500 to about 2,000 weight average molecular weight. The alkoxylated polyethyleneimine polymer further comprises:
(1) one or two alkoxylation modifications per nitrogen atom by a polyalkoxylene chain having an average of about 1 to about 50, preferably about 10 to about 45 alkoxy moieties per modification, wherein the terminal alkoxy moiety of the alkoxylation modification is capped with hydrogen, a C₁-C₄ alkyl or mixtures thereof, preferably the alkoxylation modification is capped with hydrogen; or
(2) an addition of one C₁-C₄ alkyl moiety and one or two alkoxylation modifications per nitrogen atom by a polyalkoxylene chain having an average of about 1 to about 50, preferably about 10 to about 45 alkoxy moieties per modification wherein the terminal alkoxy moiety is capped with hydrogen, a C₁-C₄ alkyl or mixtures thereof, preferably the alkoxylation modification is capped with hydrogen; or
(3) a combination thereof; and
wherein the alkoxy moieties comprises ethoxy (EO) and/or propoxy (PO) and/or butoxy and wherein when the alkoxylation modification comprises EO it also comprises PO or BO.

Preferably, the weight average molecular weight per polyalkoxylene chain is from 400 to 8,000 preferably from 600 to 4,000, more preferably 800 to 2,000. Preferably, the weight average molecular weight of the alkoxylated polyethyleneimine is from 8,000 to 40,000, preferably 10,000 to 30,000.

If the polyalkoxylene chain comprises an ethoxy and a propoxy moiety, the propoxy moiety is preferably in a terminal position. If the polyalkoxylene chain comprises an ethoxy and a butoxy moiety but no propoxy moiety, the butoxy moiety is preferably in a terminal position.

Preferably, the polyalkoxylene chain comprises ethoxy and propoxy moieties, more preferably in a number ratio of 1:1 to 2:1.

Preferred for use herein are alkoxylated polyalkyleneimine in which the number of ethoxy moieties of a polyalkoxylene chain is from 22 to 26, the number of propoxy moieties of a polyalkoxylene chain is from 14 to 18 and preferably the polyalkoxylene chain is free of butoxy moieties. Preferably this alkoxylated polyalkyleneimine polymer has a molecular weight of from 25,000 to about 30,000. More preferred for use herein are alkoxylated polyalkyleneimine in which the number of ethoxy moieties of a polyalkoxylene chain is from 8 to 12, and the number of propoxy moieties is from 5 to 9 and preferably the polyalkoxylene chain is free of butoxy moieties. Preferably this alkoxylated polyalkyleneimine polymer has a molecular weight of from 10,000 to about 15,000. Preferably these preferred alkoxylated polymers have a polyethyleneimine backbone with a molecular weight of from about 400 to about 800.

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than about 5%, more preferably less than 3% by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Compositions comprising higher levels of R7R8R9AO tend to be instable.

The composition of the invention comprises anionic surfactant, the anionic surfactant can be any anionic cleaning surfactant, preferably the anionic surfactant comprises a sulphate anionic surfactant, more preferably an alkyl sulphate and/or alkyl alkoxylated sulfate anionic surfactant, preferably an alkyl alkoxylated sulphate, preferably the alkoxylated anionic surfactant has an average alkoxylation degree of from about 0.2 to about 3, preferably from about 0.2 to about 2, most preferably from about 0.2 to about 1.0. Also preferred are branched anionic surfactants having a weight average level of branching of from about 5% to about 40%.

Preferably the composition of the invention comprises from about 1% to about 60%, preferably from about 5% to about 50%, more preferably from about 8% to about 40% by weight of the composition of total surfactant. Preferably the composition of the invention comprises from about 5% to about 40% by weight of the composition of anionic surfactant, more preferably from about 8% to about 35%, yet more preferably from about 10% to about 30%.

Preferably, the composition of the invention comprises from 0.1% to about 2%, more preferably less than 1.5% by weight of the composition of non-ionic surfactants. It has been found that the compositions with this low level of non-ionic surfactant can provide a more robust cleaning system.

According to the second aspect of the invention, there is provided the use of a
i) low-cut amine oxide of formula R1R2R3AO wherein R1 and R2 are selected from hydrogen, C1-C4 alkyls and mixtures thereof and wherein R3 is selected from C10 alkyls and mixtures thereof; and
ii) an amphiphilic alkoxylated polyalkyleneimine in manual dishwashing to provide suds longevity in soft water. Preferably, the hand dishwashing composition comprises anionic surfactant and amine oxide surfactant in a ratio of from about 5:1 to about 1:1, preferably 4:1 to 2:1, most preferably 3.5:1 to 2.5:1.

The elements of the method and composition of the invention described in connection with the first aspect of the invention apply mutatis mutandis to the second aspect of the invention.

For the purpose of this invention “dishware” herein includes cookware and tableware.

### DETAILED DESCRIPTION OF THE INVENTION

### Definition

As used herein, the singular forms “a”, “an”, and “the” include both singular and plural referents unless the context clearly dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

The present invention envisages a method of manually washing dishware with soft water using a cleaning composition, preferably in liquid form. The detergent composition comprises a surfactant system comprising anionic and amine oxide surfactant and an amphiphilic alkoxylated polyalkyleneimine It provides very good cleaning and long lasting suds in soft water.

Method of the Invention

The method of the invention comprises the steps of:
i) delivering a cleaning composition to a volume of soft water (i.e., water having a hardness of less than 10 gpg, preferably less than 5 gpg) to form a wash liquor. The concentration of the cleaning composition is preferably from about 0.05% to about 1%, more preferably from 0.08 to 2% by weight of the wash liquor.
ii) immersing the dishware into the wash liquor and cleaning the dishware, preferably with a cleaning implement; and
iii) optionally but preferably rinsing the dishware.

The washing temperature can be any temperature preferably selected from about 10° C. to about 60° C., more preferably from about 20° C. to about 55° C., most preferably from about 30° C. to about 50° C.

In the method of the invention the composition is applied in diluted form. Soiled dishware is contacted with an effective amount, typically from about 0.5 ml to about 20 ml (per about 25 dishes being treated), preferably from about 3 ml to about 10 ml, of the cleaning composition, preferably in liquid form, of the present invention diluted in water. The actual amount of cleaning composition used will be based on the judgment of user, and will typically depend upon factors such as the particular product formulation of the composition, including the concentration of active ingredients in the composition, the number of soiled dishware to be cleaned, the degree of soiling on the dishes, and the like. Generally, from about 0.01 ml to about 150 ml, preferably from about 3 ml to about 40 ml of a liquid composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The water used is soft water having a hardness of less than 10 gpg, preferably less than 5 gpg. The soiled dishware is immersed in the sink containing the diluted compositions then obtained, where contacting the soiled surface of the dishware with a cloth, sponge, or similar article cleans them. The cloth, sponge, or similar article may be immersed in the washing liquor prior to being contacted with the dishware surface, and is typically contacted with the dishware surface for a period of time ranged from about 1 to about 10 seconds, although the actual time will vary with each application and user. The contacting of cloth, sponge, or similar article to the dish surface is preferably accompanied by a concurrent scrubbing of the dishware surface. The dishware can be optionally rinsed.

The Cleaning Composition

The cleaning composition is a hand dishwashing cleaning composition, preferably in liquid form. It typically contains from 30% to 95%, preferably from 40% to 90%, more preferably from 50% to 85% by weight of the composition of a liquid carrier in which the other essential and optional components are dissolved, dispersed or suspended. One preferred component of the liquid carrier is water.

Preferably the pH of the composition is adjusted to between 3 and 14, more preferably between 4 and 13, more preferably between 6 and 12 and most preferably between 8 and 10. The pH is measured as a 10 wt % product solution in deionised water at 20° C. The pH of the composition can be adjusted using pH modifying ingredients known in the art.

The composition can comprise 1% to 60%, preferably from 5% to 50%, more preferably from 8% to 40% of total surfactant. In addition to the anionic and amine oxide surfactant the composition can optionally comprise non-ionic surfactant, zwitterionic and/or cationic surfactant.

Viscosity

The composition of the present invention can be Newtonian or non-Newtonian liquid, preferably Newtonian, with a viscosity of between 10 centipoises (cps) and 5,000 cps at 20° C. and, alternatively between 50 cps and 2,000 cps, or between 100 cps and 1,500 cps, or between 150 cps and 1,000 cps, alternatively combinations thereof.

Viscosity is measured with a BROOFIELD DV-E viscometer, at 20° C., spindle number 31. The following rotations per minute (rpm) should be used depending upon the viscosity: Between 300 cps to below 500 cps is at 50 rpm; between 500 cps to less than 1,000 cps is at 20 rpm; from 1,000 cps to less than 1,500 cps at 12 rpm; from 1,500 cps to less than 2,500 cps at 10 rpm; from 2,500 cps, and greater, at 5 rpm. Those viscosities below 300 cps are measured at 12 rpm with spindle number 18.

Amine Oxide Surfactant

The amine oxide surfactant in combination with the amphiphilic alkoxylated polyalkyleneimine improves the cleaning and the longevity of suds under soft water conditions.

Low-Cut Amine Oxide

Within the meaning of the present invention “low-cut amine oxide” means an amine oxide of formula: R1R2R3AO wherein R1 and R2 are selected from hydrogen, C1-C4 alkyls and mixtures thereof and wherein R3 is selected from C10 alkyls and mixtures thereof.

Mid-Cut Amine Oxide

Within the meaning of the present invention “mid-cut amine oxide” means an amine oxide of formula: R4R5R6AO wherein R4 and R5 are selected from hydrogen, C1-C4 alkyls and mixtures thereof and wherein R6 is selected from C12-C16 alkyls and mixtures thereof.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the composition of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[x1*wt % branched alcohol 1 in alcohol 1+x2*wt % branched alcohol 2 in alcohol 2+ . . . )/(x1+x2+ . . . )]*100

wherein x1, x2, are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the anionic surfactant is a branched anionic surfactant having a level of branching of from about 5% to about 40%, preferably from about 10 to about 35% and more preferably from about 20% to about 30%, more preferably the branched anionic surfactant comprises more than 50% by weight thereof of an alkyl ethoxylated sulphate. Preferably the branched anionic surfactant has an average ethoxylation degree of from about 0.2 to about 3, more preferably from 0.2 to 1 and preferably an average level of branching of from about 5% to about 40%.

Preferably, the anionic surfactant comprises at least 50%, more preferably at least 60% and preferably at least 70% by weight of the anionic surfactant, more preferably the branched anionic surfactant comprises more than 50% by weight thereof of an alkyl ethoxylated sulphate having an ethoxylation degree of from about 0.2 to about 3, preferably 0.2 to 1 and preferably a level of branching of from about 5% to about 40%.

Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial—Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

Sulphonate Surfactants

Suitable sulphonate surfactants for use herein include water-soluble salts of C8-C18 alkyl or hydroxyalkyl sulphonates, C11-C18 alkyl benzene sulphonates (LAS), modified alkylbenzene sulphonate (MLAS), methyl ester sulphonate (MES) and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic surfactant, when present, is comprised in an amount of less than 2%, preferably less than 1.5% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y (I) wherein
R¹ is a saturated or unsaturated C6-22 alkyl residue, preferably C8-18 alkyl residue, in particular a saturated C10-16 alkyl residue, for example a saturated C12-14 alkyl residue; X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetain.

Amphiphilic alkoxylated polyalkyleneimine polymer

Amphiphilic alkoxylated polyalkyleneimine

The composition of the invention comprises from about 0.1% to about 2%, preferably from more than about 0.5% to about 1.5% by weight of the composition of an amphiphilic alkoxylated polyalkyleneimine, preferably an amphiphilic alkoxylated polyethyleneimine polymer.

Amphiphilic alkoxylated polyethyleneimine polymers will comprise ethoxy (EO) and/or propoxy (PO) and/or butoxy (BO) groups within their alkoxylation chains, when comprising EO also comprising PO and/or BO. Prefered amphiphilic alkoxylated polyethylene polymers comprise EO and PO groups within their alkoxylation chains. Hydrophilic alkoxylated polyethyleneimine polymers solely comprising ethoxy (EO) units within the alkoxylation chain are outside the scope of this invention.

The amphiphilic alkoxylated polyethyleneimine polymer of the composition of the invention has a polyethyleneimine backbone having from about 400 to about 5,000 weight average molecular weight, preferably from about 400 to about 2,000 weight average molecular weight, even more preferably from about 400 to about 1,000 weight average molecular weight, most preferably about 600 weight average molecular weight.

The alkoxylation chains within the amphiphilic alkoxylated polyethyleneimine polymer of the present composition have from about 400 to about 3,000 weight average molecular weight, preferably from about 600 to about 2,500 weight average molecular weight, more preferably from about 750 to about 1,000 weight average molecular weight, most preferably about 850 weight average molecular weight per alkoxylated chain.

The amphiphilic alkoxylated polyethyleneimine polymer of the present composition have from about 8,000 to about 40,000 weight average molecular weight, preferably from about 9,000 to about 30,000 weight average molecular weight, more preferably from about 10,000 to about 15,000 weight average molecular weight.

Another preferred amphiphilic alkoxylated polyethyleneimine polymer for use herein has a weight average molecular weight per polyalkoxylene chain of from 400 to 8,000 preferably from 600 to 4,000, more preferably 800 to 2,000. Preferably, the weight average molecular weight of the alkoxylated polyethyleneimine is from 8,000 to 40,000, preferably 10,000 to 30,000, especially preferred is an amphiphilic alkoxylated polyethyleneimine polymer with a weight average molecular weight of the alkoxylated polyethyleneimine is from 25,000 to 30,000 and a weight average molecular weight per polyalkoxylene chain of from 1,500 to 2,500.

The alkoxylation of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification, wherein the terminal alkoxy moiety of the alkoxylation modification is capped with hydrogen, a C₁-C₄ alkyl or mixtures thereof; or (2) an addition of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C₁-C₄ alkyl or mixtures thereof, preferably hydrogen; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

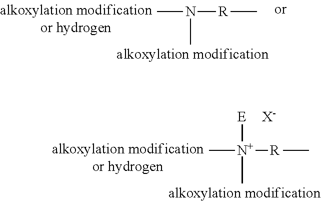

Also, for example, but not limited to, below is shown possible modifications to internal nitrogenatoms in the polyethyleneimine backbone where R represents an ethylene spacer and E represents a C₁-C₄ alkyl moiety and X— represents a suitable water soluble counterion.

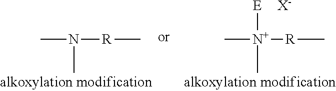

The alkoxylation modification of the polyethyleneimine backbone consists of the replacement of a hydrogen atom by a polyalkoxylene chain having an average of about 1 to about 50 alkoxy moieties, preferably from about 5 to about 45 alkoxy moieties, most preferably from about 10 to about 20 alkoxy moieties. The alkoxy moieties are selected from ethoxy (EO), propoxy (PO),butoxy (BO), and mixtures thereof. Alkoxy moieties solely comprising ethoxy units are outside the scope of the invention though. Preferably, the polyalkoxylene chain is selected from ethoxy/propoxy block moieties. More preferably, the polyalkoxylene chain is ethoxy/propoxy block moieties having an average degree of ethoxylation from about 3 to about 30 and an average degree of propoxylation from about 1 to about 20, more preferably ethoxy/propoxy block moieties having an average degree of ethoxylation from about 5 to about 15 and an average degree of propoxylation from about 5 to about 10, or alternatively an average degree of ethoxylation from about 20 to about 30 and an average degree of propoxylation from about 10 to about 20.

More preferably the ethoxy/propoxy block moieties have a relative ethoxy to propoxy unit ratio between 3 to 1 and 1 to 1, preferably between 2 to 1 and 1 to 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Most preferably the degree of quaternization is 0%.

A preferred polyethyleneimine has the general structure of formula (I):

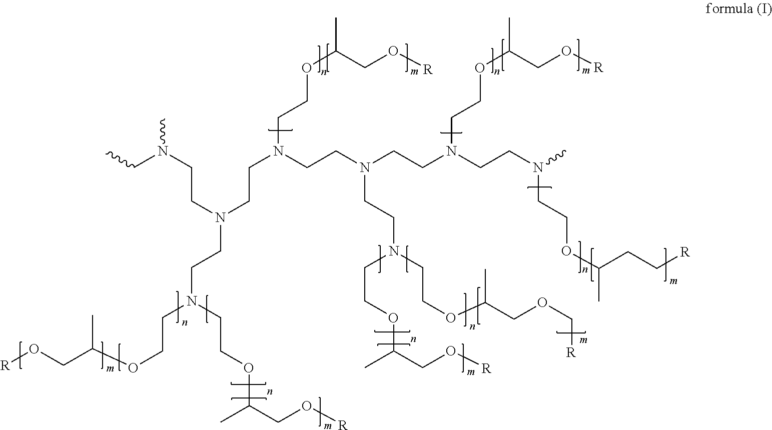

wherein the polyethyleneimine backbone has a weight average molecular weight of about 600, n of formula (I) has an average of about 10, m of formula (I) has an average of about 7 and R of formula (I) is selected from hydrogen, a C₁-C₄ alkyl and mixtures thereof, preferably hydrogen. The degree of permanent quaternization of formula (I) may be from 0% to about 22% of the polyethyleneimine backbone nitrogen atoms. The molecular weight of this polyethyleneimine preferably is between 10,000 and 15,000.

An alternative polyethyleneimine has the general structure of formula (I) but wherein the polyethyleneimine backbone has a weight average molecular weight of about 600, n of formula (I) has an average of about 24, m of formula (I) has an average of about 16 and R of formula (I) is selected from hydrogen, a C₁-C₄ alkyl and mixtures thereof, preferably hydrogen. The degree of permanent quaternization of formula (I) may be from 0% to about 22% of the polyethyleneimine backbone nitrogen atoms. The molecular weight of this polyethyleneimine preferably is between 25,000 and 30,000.

Most preferred polyethyleneimine has the general structure of formula (I) wherein the polyethyleneimine backbone has a weight average molecular weight of about 600, n of formula (I) has an average of about 10, m of formula (I) has an average of about 7 and R of formula (I) is hydrogen. The degree of permanent quaternization of formula (I) is 0% of the polyethyleneimine backbone nitrogen atoms. The molecular weight of this polyethyleneimine preferably is about from about 12,200 to 12,600.

Alternatively the polyethyleneimine has the general structure of formula (I) wherein the polyethyleneimine backbone has a weight average molecular weight of about 600, n of formula (I) has an average of about 24, m of formula (I) has an average of about 16 and R of formula (I) is hydrogen. The degree of permanent quaternization of formula (I) is 0% of the polyethyleneimine backbone nitrogen atoms. The molecular weight of this polyethyleneimine preferably is about from about 27,500 to 28,500.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, as described in more detail in WO 2007/135645.

Organic Solvents

The present compositions may optionally comprise an organic solvent. Suitable organic solvents include C₄₋₁₄ ethers and diethers, polyols, glycols, alkoxylated glycols, C₆-C₁₆ glycol ethers, alkoxylated aromatic alcohols, aromatic alcohols, aliphatic linear or branched alcohols, alkoxylated aliphatic linear or branched alcohols, alkoxylated C₁-C₅ alcohols, C₈-C₁₄ alkyl and cycloalkyl hydrocarbons and halohydrocarbons, and mixtures thereof. Preferably the organic solvents include alcohols, glycols, and glycol ethers, alternatively alcohols and glycols. In one embodiment, the liquid detergent composition comprises from 0% to less than 50% of a solvent by weight of the composition. When present, the liquid detergent composition will contain from 0.01% to 20%, alternatively from 0.5% to 15%, alternatively from 1% to 10% by weight of the liquid detergent composition of said organic solvent. Non-limiting examples of specific solvents include propylene glycol, polypropylene glycol, propylene glycol phenyl ether, ethanol, and combinations thereof. In one embodiment, the composition comprises from 0.01% to 20% of an organic solvent by weight of the composition, wherein the organic solvent is selected from glycols, polyalkyleneglycols, glycol ethers, ethanol, and mixtures thereof.

Hydrotrope

The composition herein optionally comprises a hydrotrope in an effective amount, i.e. from 0% to 15%, or from 0.5% to 10% , or from 1% to 6%, or from 0.1% to 3%, or combinations thereof, so that the liquid dish detergent compositions are compatible or more compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. In one embodiment, the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. In one embodiment, an isotropic dish detergent composition is provided. In one embodiment, the composition comprises 0.1% to 3% of a hydrotrope by weight of the composition, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

The composition herein may comprise a number of optional ingredients such as builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters such as salt especially NaCl, and pH adjusters and buffering means.

### EXAMPLES

Evaluation of the Suds Mileage Performance in Hand Dish Detergent Compositions

The suds mileage performance of hand dishwashing detergent compositions (Examples A-F) was assessed under dilute conditions (detergent concentration: 0.12 wt %) according to the protocol described herein. Suds mileage performance of the different compositions comprising n-C10 dimethyl amine oxide (B), alkoxylated polyethyleneimine (C, D), or mixtures thereof (E,F) has been assessed versus a nil n-C10 dimethyl amine oxide nil alkoxylated polyethyleneimine reference composition A at 35° C. and 46° C. in soft water hardness condition (2 gpg) in presence of a greasy soil and averaged. Compositions E and F comprising a mixture of both n-C10 dimethyl amine oxide and alkoxylated polyethyleneimine according to the invention clearly show an improved suds mileage performance compared to comparative examples A-D outside the scope of invention, solely comprising one or none of the n-C10 dimethyl amine oxide or alkoxylated polyethyleneimine compounds.

| | Level (wt % - as 100% active) | | | | | |
|---|---|---|---|---|---|---|
| | A | B | C | D | E | F |
| NaAE0.6S | 22.5% | 22.5% | 22.5% | 22.5% | 22.5% | 22.5% |
| n-C12-14 Di Methyl | 6.1% | 5.1% | 6.1% | 6.1% | 5.1% | 5.1% |
| Amine Oxide | | | | | | |
| n-C10 Di Methyl | — | 1% | — | — | 1% | 1% |
| Amine Oxide | | | | | | |
| (DMAO) | | | | | | |
| Neodol 91-8 | 1% | 1% | 1% | 1% | 1% | 1% |
| Lutensol XP80 | 0.4% | 0.4% | 0.4% | 0.4% | 0.4% | 0.4% |
| Alkoxylated | — | — | 1% | — | 1% | — |
| Polyethyleneimine 1 | | | | | | |
| (PEI600EO10PO7) | | | | | | |
| Alkoxylated | — | — | — | 1% | — | 1% |
| Polyethyleneimine 2 | | | | | | |
| (PEI600EO24PO16) | | | | | | |
| Sodium Chloride | 0.7% | 0.7% | 0.7% | 0.7% | 0.7% | 0.7% |
| Na3-citrate•2H2O | 1% | 1% | 1% | 1% | 1% | 1% |
| Poly Propylene Glycol | 0.9% | 1% | 0.7% | 1.1% | 0.7% | 1.2% |
| Ethanol | 2.2% | 2.2% | 1.7% | 1.7% | 1.6% | 1.6% |
| Sodium Hydroxide | 0.26% | 0.27% | 0.25% | 0.26% | 0.25% | 0.26% |
| Minors + water | To 100% | To 100% | To 100% | To 100% | To 100% | To 100% |
| pH (@ 10% solution) | 9 | 9 | 9 | 9 | 9 | 9 |

PEI600EO10PO7: Polyethyleneimine backbone with MW about 600, comprising EO - terminal PO block polyalkoxylate side chains comprising each on average 10 EO and 7 PO units and hydrogen capped, MW 12417.
PEI600EO24PO16: Polyethyleneimine backbone with MW about 600, comprising EO - terminal PO block polyalkoxylate side chains comprising each on average 24 EO and 16 PO units and hydrogen capped, MW 28000.

| | Suds mileage | Suds mileage | Avg Suds |
|---|---|---|---|
| | performance | performance | mileage |
| | 35° C. | 46° C. | performance |
| Reference: Composition | 100 | 100 | 100 |
| A (nil n-C10 DMAO - | | | |
| nil PEI) | | | |
| Composition B (n-C10 | 95 | 96 | 95 |
| DMAO) | | | |
| Composition C (nil n- | 103 | 102 | 102 |
| C10 DMAO - | | | |
| PEI600EO10PO7) | | | |
| Composition D (nil n- | 107 | 104 | 105 |
| C10 DMAO - | | | |
| PEI600EO24PO16) | | | |
| Composition E (n-C10 | 108 | 109 | 109 |
| DMAO - | | | |
| PEI600EO10PO7) | | | |
| Composition F (n-C10 | 107 | 111 | 109 |
| DMAO - | | | |
| PEI600EO24PO16) | | | |

Suds Mileage Testing Protocol:

The evolution of the foam volume generated by a certain solution of dishwashing liquid is followed at specified soft water hardness (2 gpg), solution temperature and cleaning composition concentration, under influence of periodic soil injections. Data are compared and expressed versus a reference product as a suds mileage index (reference product has suds mileage index of 100).

A defined amount of dishwashing product depending on the targeted product concentration is dispensed through a pipette with a flow rate of 0.67 ml/sec at a height of 37 cm above the sink bottom surface into a water stream that starts filling up a sink (dimensions: cylinder—Diameter 300 mm & height 288 mm) to 4 L with a constant pressure of 4 bar. With this pressure an initial suds volume is generated in the sink.

After recording the initial foam volume (average foam height*sink surface area) a fixed amount of soil (6 ml) will be injected almost instantaneously in the middle of the sink, while a paddle (metal blade 10×5 cm, positioned in the middle of the sink at the air liquid interface under an angle of 45 degrees) will rotate 20 times into the solution at 85 rpm. This step is followed immediately by another measurement of the total suds volume. The soil injecting, paddling and measuring steps are repeated until the measured foam volume reaches a minimum level, which is set at 400 cm³. The amount of soil additions needed to get to that level is considered as the mileage (suds longevity) of that specific sample.

The complete process is repeated 20 times per sample and per testing condition (temperature). As a final result the average mileage of the 20 replicates is calculated for each sample and averaged across testing conditions. Comparing the average mileage of the test sample versus that of the reference sample, indicates the performance of the test sample versus that reference sample, and is expressed as a suds mileage index, calculated as (average number of soil additions of test sample/average number of soil additions of reference sample)*100.

Soil Composition:

| Ingredient | Weight % |
|---|---|
| Crisco oil | 12.730 |
| Crisco shortening | 27.752 |
| Lard | 7.638 |
| Refined Rendered Edible Beef Tallow | 51.684 |
| Oleic Acid, 90% (Techn) | 0.139 |
| Palmitic Acid, 99+% | 0.036 |
| Stearic Acid, 99+% | 0.021 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manually washing dishware in soft water comprising the steps of delivering a cleaning composition to a volume of soft water to form a wash liquor and immersing the dishware in the liquor wherein the cleaning composition comprises anionic surfactant and amine oxide surfactant and wherein the amine oxide surfactant comprises:
a) from about 5% to about 40% by weight of the amine oxide of low-cut amine oxide of formula R1R2R3AO wherein R1 and R2 are independently selected from hydrogen, C1-C4 alkyls or mixtures thereof and wherein R3 is selected from C10 alkyls or mixtures thereof; and
b) from about 60% to about 95% by weight of the amine oxide of mid-cut amine oxide of formula R4R5R6AO wherein R4 and R5 are independently selected from hydrogen, C1-C4 alkyls or mixtures thereof and wherein R6 is selected from C12-C16 alkyls or mixtures thereof; and
an amphiphilic alkoxylated polyalkyleneimine wherein the amphiphilic alkoxylated polyalkyleneimine is an alkoxylated polyethyleneimine polymer comprising a polyethyleneimine backbone having from about 400 to about 5,000 weight average molecular weight and the alkoxylated polyethyleneimine polymer further comprises:
(1) one or two alkoxylation modifications per nitrogen atom by a polyalkoxylene chain having an average of about 1 to about 50 alkoxy moieties per modification, wherein the terminal alkoxy moiety of the alkoxylation modification is capped with hydrogen, a C₁-C₄ alkyl or mixtures thereof;
(2) an addition of one C₁-C₄ alkyl moiety and one or two alkoxylation modifications per nitrogen atom by a polyalkoxylene chain having an average of about 1 to about 50 alkoxy moieties per modification wherein the terminal alkoxy moiety is capped with hydrogen, a C₁-C₄ alkyl or mixtures thereof; or
(3) a combination thereof; and
wherein the alkoxy moieties comprises ethoxy (EO) and/or propoxy (PO) and/or butoxy (BO) and wherein when the alkoxylation modification comprises EO it also comprises PO or BO.

2. The method according to claim 1 wherein the weight average molecular weight per polyalkoxylene chain is from 400 to 8,000.

3. The method according to claim 1 wherein the weight average molecular weight of the alkoxylated polyethyleneimine is from 8,000 to 40,000.

4. The method according to claim 1 wherein the polyalkoxylene chain comprises a propoxy moiety in a terminal position.

5. The method according to claim 1 wherein the polyalkoxylene chain comprises ethoxy and propoxy moieties in a ratio of 1:1 to 2:1.

6. The method according to claim 1 wherein the number of ethoxy moieties of a polyalkoxylene chain is from 22 to 26, and the number of propoxy moieties of a polyalkoxylene chain is from 14 to 18.

7. The method according to claim 6 wherein the polyalkoxylene chain is free of butoxy moieties.

8. The method according to claim 1 wherein the number of ethoxy moieties of a polyalkoxylene chain is from 8 to 12, and the number of propoxy moieties of a polyalkoxylene chain is from 5 to 9.

9. The method according to claim 8 wherein the polyalkoxylene chain is free of butoxy moieties.

10. The method according to claim 1 wherein R3 is n-decyl and R1 and R2 are both methyl.

11. The method according to claim 1 comprising from about 3% to about 15% by weight of the composition of the amine oxide surfactant wherein the amine oxide surfactant comprises:
a) from about 10% to about 30% by weight of the amine oxide of the low-cut amine oxide of formula R1R2R3AO wherein R1 and R2 are both methyl and R3 is n-decyl;
b) from about 70% to about 90% by weight of the amine oxide of the mid-cut amine oxide of the formula R4R5R6AO.

12. The method according to claim 1 comprising less than about 5% by weight of the amine oxide of an amine oxide of formula R7R8R9AO wherein R7 and R8 are independently selected from hydrogen, C1-C4 alkyls or mixtures thereof and wherein R9 is selected from C8 alkyls or mixtures thereof.

13. The method according to claim 1 wherein the anionic surfactant and the amine oxide surfactant are in a weight ratio of from about 5:1 to about 1:1.

14. The method according to claim 1 wherein the composition comprises from about 0.1% to about 2% by weight of the composition of the alkoxylated polyalkyleneimine

15. The method according to claim 1 further comprising a poly alkylene glycol having a molecular weight greater than 1,000.

16. The method according to claim 1 wherein the anionic surfactant comprises a sulphate anionic surfactant.

17. The method according to claim 1 wherein the amount of anionic surfactant is from about 10% to about 40% by weight of the composition.

18. The method according to claim 1 wherein the composition further comprises from 0.1% to 2% by weight of the composition of nonionic surfactant.

19. The method according to claim 1 wherein the total level of surfactant is from about 10% to about 40% by weight of the composition.

20. The method according to claim 1 wherein the composition has a pH measured at 10% dilution in distilled water at 20° C. of from about 8 to about 10.
